(19) United States
(12) Patent Application Publication
(10) Pub. No.: US 2015/0295950 A1
(43) Pub. Date: Oct. 15, 2015

(54) METHOD, APPARATUS AND SYSTEM FOR DEFENDING AGAINST NETWORK ATTACK

(71) Applicant: Tencent Technology (Shenzhen) Co., Ltd., Shenzhen (CN)

(72) Inventors: Xi CHEN, Shenzhen (CN); Jian LIU, Shenzhen (CN)

(73) Assignee: TENCENT TECHNOLOGY (SHENZHEN) CO., LTD., Shenzhen (CN)

(21) Appl. No.: 14/729,966

(22) Filed: Jun. 3, 2015

Related U.S. Application Data
(63) Continuation of application No. PCT/CN2014/084082, filed on Aug. 11, 2014.

(30) Foreign Application Priority Data
Aug. 12, 2013 (CN) 201310350034.9

(51) Int. Cl. H04L 29/06

(52) U.S. Cl. CPC H04L 63/1441; H04L 63/0245; H04L 63/123; H04L 63/1458

(57) ABSTRACT

A method, apparatus and system for defending against a network attack are provided in the disclosure. The method includes: receiving, by a defending server, data submitted by a client; extracting by the defending server, a first authentication value from the data; calculating by the defending server, a second authentication value based on a predetermined algorithm; and forwarding by the defending server, the data to a corresponding network server in a case that the first authentication value matches with the second authentication value. The method, apparatus and system for defending against a network attack described above may effectively defend against the network attack.

### CROSS REFERENCES OF RELATED APPLICATIONS

The application is a continuation of PCT Application No. PCT/CN2014/084082, filed on Aug. 11, 2014, which claims priority to the Chinese Patent Application No. 201310350034.9, entitled “METHOD, APPARATUS AND SYSTEM FOR DEFENDING AGAINST NETWORK ATTACK”, filed on Aug. 12, 2013 with the State Intellectual Property Office of People's Republic of China, which is incorporated herein by reference in their entireties.

### FIELD

The disclosure relates to a network security technology, and particularly to a method, apparatus and system for defending against a network attack.

### BACKGROUND

In the current industry, an interactivity of a protocol is mostly applied in a method for identifying an authenticity of a packet. A message in a challenge-response way is embedded in a communication process to challenge an initiator of the communication process. It is determined whether a request initiated by the initiator is a malicious request based on a response result from the initiator after the challenge.

Taking a defending algorithm against an attack to a Distribution Denial Of Service (DDoS) in the current industry as an example, an implementation process includes: a client initiates a request to a server; a defending device initiates a challenge for the request of the client after the request of the client is analyzed; a normal client is able to make a correct response to the challenge, and an attacker is not able to make a correct response to the challenge; the defending device checks the response of the client, and forwards the request initiated by the client to the server in a case that the response of the client is correct; the server makes a response to the request.

For a public protocol (such as HTTP or DNS), it is able to effectively check a malicious data packet by the challenge-response way. However, there are the following two disadvantages in the challenge-response way for a proprietary protocol.

Whether a response can be made for the proprietary protocol according to a requirement of the defending device depends on a way and details for realizing the proprietary protocol. In a case that the proprietary protocol is not public or is frequently changed, it is required for the defense device to constantly modify a challenge way in a defending algorithm to reply, the maintenance cost of the defending device is greatly increased. Also, in a case that the defending algorithm and defending device are provided by a third party, the defending device can not only ensure a defense effect but also have an influence on privacy of the proprietary protocol by using the challenge-response way.

In a case that data is encrypted and compressed, it is required for the defense device to decrypt and decompress the communication data if using the challenge-response way. In this way, performance cost of the defense device is greatly increased, and it is also required to maintain key information of both parties of communication on the defense device, which increases complexity of the device.

### SUMMARY

In view of this, it is required to provide a method, apparatus and system for defending against a network attack, to effectively defend against the network attack.

A method for defending against a network attack applied in a defending server is provided, which includes: receiving data submitted by a client; extracting a first authentication value from the data; calculating a second authentication value based on a predetermined algorithm; and forwarding the data to a corresponding network server in a case that the first authentication value matches with the second authentication value.

An apparatus for defending against a network attack applied in a defending server is provided, which includes: a data receiving module configured to receive data submitted by a client; an extracting module configured to extract a first authentication value from the data; a calculating module configured to calculate a second authentication value based on a predetermined algorithm; and an authentication module configured to forward the data to a corresponding network server in a case that the first authentication value matches with the second authentication value.

A method for defending against a network attack is provided, which includes: adding, by a client, a first authentication value into data to be sent, and sending the data to be sent to a defending server; receiving, by the defending server, the data to be sent and extracting the first authentication value from the data; calculating, by the defending server, a second authentication value based on a predetermined algorithm; and forwarding, by the defending server, the data to a corresponding network server in a case that the first authentication value matches with the second authentication value.

A system for defending against a network attack is provided, which includes a client, a defending server and a network server; the client is configured to add a first authentication value into data to be sent, and send the data to be sent to the defending server; the defending server is configured to receive the data to be sent, extract a first authentication code from the data, calculate a second authentication code based on a predetermined algorithm, and forward the data to the network server in a case that the first authentication value matches with the second authentication value.

In the method, apparatus and system for defending against a network attack in the embodiments of the invention, the first authentication value may be calculated by implanting the first specified factor into the client application, and the client adds the first authentication value into the data to be sent when the client performs data interaction with the network server. In other hand, the defending server may calculate the second authentication value by itself based on the second specified factor. The second specified factor may be stored in the defending server. It is easy to recognize whether the client is a possible attack source by comparing the first authentication value with the second authentication value. Thus, abnormal data may be discarded, and network attacks for the network server 30 are decreased. In addition, the method, apparatus and system in the embodiments may run well on the basis of a proprietary network protocol. It may be understood that the method, apparatus and system of the embodiment is not limited to run on the basis of the proprietary network protocol.

In order to make the described and other objects, features and advantages of the disclosure more obvious and easier to be understood, embodiments are exemplified below in conjunction with drawings, which are illustrated in detail as follows.

### BRIEF DESCRIPTION OF THE DRAWINGS

FIG. 1 is a schematic diagram of a system for defending against a network attack according to a first embodiment of the invention;

FIG. 2 is a schematic diagram of an interaction when the system for defending against a network attack in FIG. 1 runs;

FIG. 3 is a flow diagram of a method for defending against a network attack according to a second embodiment of the invention;

FIG. 4 is a flow diagram of a method for defending against a network attack according to a third embodiment of the invention; and

FIG. 5 is a block diagram of a structure of an apparatus for defending against a network attack according to a fourth embodiment of the invention.

### DETAILED DESCRIPTION

In order to further set forth the technical solutions and effects of the disclosure, the embodiments, structures, features and effects according to the disclosure are illustrated in detail below in conjunction with drawings and the embodiments.

The embodiments of the invention provide a system for defending against a network attack, which can decrease attacks to a network server in a distributed network. A network server provides various network services to a user via a network, such as, a game, an audio/video call, an instant communication. In some embodiments, these network services are realized based on one or more proprietary network protocols. These proprietary network protocols are not public.

### First Embodiment

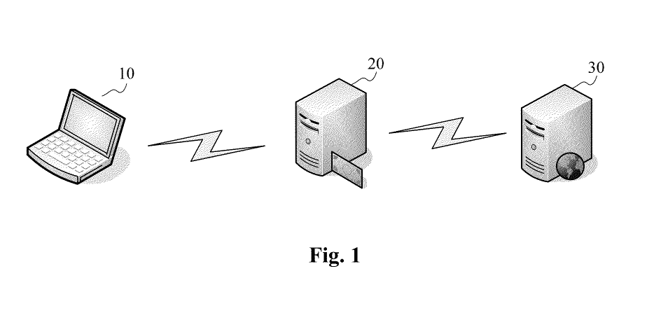

FIG. 1 is a schematic diagram of a system for defending against a network attack according to a first embodiment. As shown in FIG. 1, the system 100 includes a client 10, a defending server 20 and a network server 30. The client 10 may be connected to the defending server 20 via a network, and the defending server 20 may be connected to the network server 30 via an intranet.

The client 10 may be a personal computer, a smart phone, a panel computer, a media player or any other electrical apparatus having a function to access a network. The client 10 utilizes various network services provided by the network server 30 via an application (such as a game client program or an instant communication client program) run therein.

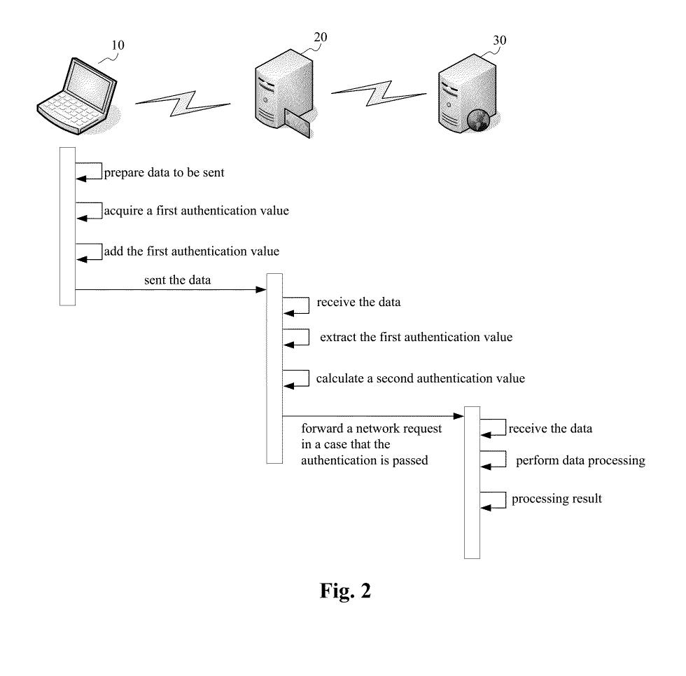

A reference is made to FIG. 2 which is a schematic diagram of an interaction when the system for defending against the network attack in FIG. 1 runs. As shown in FIG. 2, the client 10 prepares data to be sent firstly. Optionally, an application generates data to be sent to the network server 30 in a running process, such as recorded voice/audio data or operation data of a user in a game client application. Then, the client 10 may acquire a first authentication value. For example, a hash value is calculated based on a first specified factor according to the Hash algorithm. The first specified factor is, for example, built in an application, and published along with the application. A second specified factor, which is the same as the first specified factor, may be stored at the server side. For example, the second specified may be stored in a server. The Hash algorithm may be, for example, a Message-Digest Algorithm 5 (MD5) which is a cryptographic hash function which produces hash values for verifying data integrity.

After the first authentication value is acquired, the client 10 adds the first authentication value into the data to be sent. Optionally, the data to be sent may be encapsulated into a data packet in a specified format by applying a proprietary protocol. Then, as shown in FIG. 2, the client 10 sends the data to the defending server 20, that is, the client 10 sends the data packet to the defending server 20.

The defending server 20 receives the data sent by the client 10, analyzes the data based on a predetermined protocol, and extracts the first authentication value from the received data. In other hand, the defending server 20 acquires the second specified factor. The second specified factor may be stored in the defending server 20. The defending server 20 calculates a second authentication value based on the second specified factor by applying the same algorithm as that applied by the client 10. In a case that the first authentication value matches with the second authentication value, for example, the first authentication value is the same as the second authentication value, then it indicates that the client 10 is not an attacker. In this case, it may be regarded that the authentication has passed, the defending server 20 forwards the received data to the network server 30. In a case that the first authentication value does not match with the second authentication value, the defending server 20 discards the data sent by the client 10. Thus, invalid data received by the network server 30 may be decreased.

The network server 30 receives the data forwarded by the defending server 20, and analyzes the data based on a predetermined protocol. Further, data processing is completed based on the data. For example, in an example the data is audio/video data. The audio/video data is forwarded to other clients, and a processing result may be returned to the client 10. In another example, the data is operation data of a user, a corresponding operation is completed by the network server 30, and a result obtained after the operation is completed is returned to the client 10.

In the system for defending against a network attack provided by the embodiment, the first authentication value may be calculated by implanting the first specified factor into the client application, and the client may add the first authentication value into the data to be sent when performing data interaction with the network server. In other hand, the defending server may calculate the second authentication value by itself based on the second specified factor. The second specified factor may be stored in the defending server. It is easy to recognize whether the client is a possible attack source by comparing the first authentication value with the second authentication value, therefore, abnormal data may be discarded, and network attacks for the network server 30 are decreased. In addition, the system in the embodiment may run well on the basis of a proprietary network protocol. It may be understood that the system of the embodiment is not limited to run on the basis of the proprietary network protocol.

### Second Embodiment

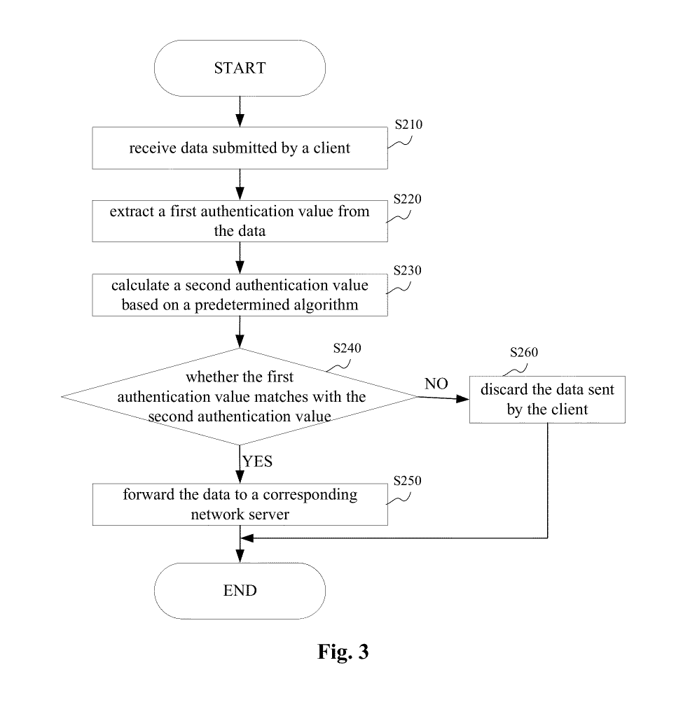

FIG. 3 is a flow diagram of a method for defending against a network attack according to a second embodiment of the invention, which may be applied in a defending server 20 shown in FIG. 1. As shown in FIG. 3, the method includes steps S210 to S260.

In S210, data submitted by a client is received.

As shown in FIG. 2, the client 10 prepares data to be sent firstly. Optionally, an application generates data to be sent to a network server 30 in a running process, such as recorded video/audio data or operation data of a user in a game client program. Then, the client 10 may acquire a first authentication value. The client 10 may add the first authentication value into the data to be sent after the first authentication value is acquired. Further, the client 10 sends the data to the defending server 20. Accordingly, the defending server 20 receives the data submitted by the client 10.

In step S220, the first authentication value is extracted from the data.

The defending server 20 may analyze the data based on a predetermined protocol, and extract the first authentication value from the received data.

In step S230, a second authentication value is calculated based on a predetermined algorithm.

The defending server 20 acquires a second specified factor, and calculates a second authentication value based on the second specified factor by applying the same algorithm as that applied by the client 10. The second specified factor may be stored in the defending server 20. For example, a hash value is calculated based on the second specified factor stored in the defending server 20 and the MD5 algorithm, the hash value is the second authentication value.

In step S240, it is determined whether the first authentication value matches with the second authentication value, and in a case that the first authentication value matches with the second authentication value, step S250 is performed in which the data is forwarded to a corresponding network server, or in a case that the first authentication value does not match with the second authentication value, step S260 is performed in which the data sent by the client is discarded.

After step S250, the network server receives the data forwarded by the defending server, performs corresponding data processing based on the data, and returns a processing result to the client.

In the method for defending against a network attack provided by the embodiment, the defending server may calculates the second authentication value by itself based on the factor stored in the server. It is easy to recognize whether the client is a possible attacker by comparing the first authentication value with the second authentication value, therefore, abnormal data may be discarded, and the network attacks for the network server are decreased. In addition, the method in the embodiment may run on the basis of a proprietary network protocol, which overcomes a defect that an existing “challenge/response” way is unable to run on the basis of the proprietary network protocol. However, it may be understood that the method in the embodiment is not limited to run on the basis of the proprietary network protocol.

### Third Embodiment

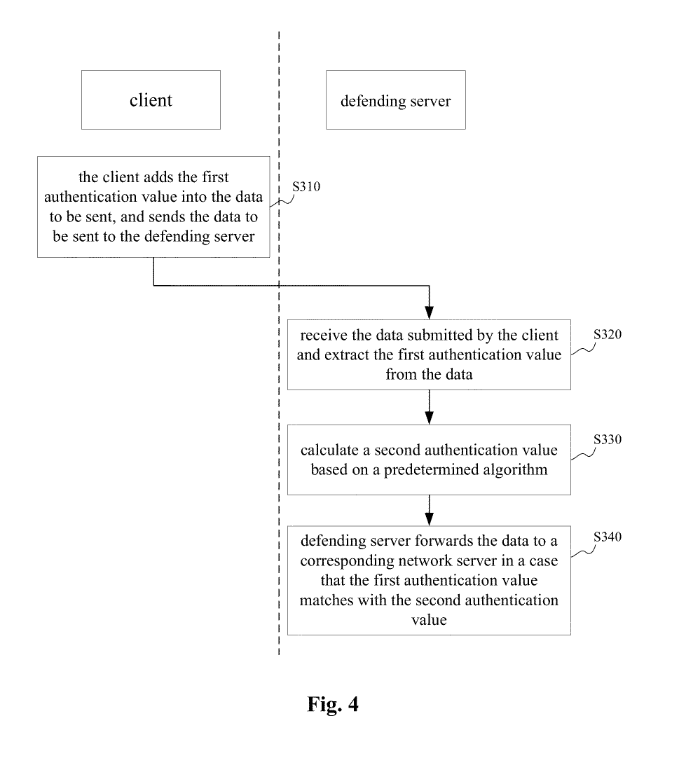

FIG. 4 is a flow diagram of a method for defending against a network attack according to a third embodiment of the invention, which may be performed by the system shown in FIG. 1. As shown in FIG. 4, the method includes steps S310 to S340.

In step S310, a client adds a first authentication value into data to be sent, and sends the data to be sent to a defending server.

As shown in FIG. 2, the client 10 prepares the data to be sent firstly. An application generates the data to be sent to a network server 30 in a running process, for example, recorded voice/audio data or operation data of a user in a game client program. Then, the client 10 may acquire a first authentication value. The client 10 may add the first authentication value to the data to be sent after the first authentication value is acquired. Further, the client 10 sends the data to the defending server 20. Accordingly, the defending server 20 receives the data submitted by the client 10.

In step S320, the defending server receives the data, and extracts the first authentication value from the data. The defending server 20 may analyze the data based on a predetermined protocol, and extract the first authentication value from the received data.

In step S330, the defending server calculates a second authentication value based on a predetermined algorithm.

The defending server 20 acquires a second specified factor, and calculates the second authentication value based on the second specified factor by applying the same algorithm as that applied in the client 10. The second specified factor may be stored in the defending server 20. For example, a hash value is calculated based on the second specified factor stored in the defending server 20 and the MD5 algorithm, the hash value is the second authentication value.

In step S340, the defending server forwards the data to a network server in a case that the first authentication value matches with the second authentication value.

Furthermore, in step S340, the defending server discards the data in a case that the first authentication value does not match with the second authentication value.

Further, after step S340, the method may also include the following step: the network server 30 performs corresponding data processing based on the data and returns a processing result to the client 10 after the data is received.

In the method for defending against a network attack provided by the embodiment, the first authentication value may be calculated by implanting the first specified factor into a client application, and the client adds the first authentication value into the data to be sent when the client performs data interaction with the network server. In other hand, the defending server may calculate the second authentication value by itself based on the second specified factor which may be stored in the defending server. It is easy to recognize whether the client is a possible attack source by comparing the first authentication value with the second authentication value, therefore, abnormal data may be discarded, and network attacks for the network server 30 are decreased. In addition, the method in the embodiment may run well on the basis of a proprietary network protocol. It may be understood that the method of the embodiment is not limited to run on the basis of the proprietary network protocol.

### Fourth Embodiment

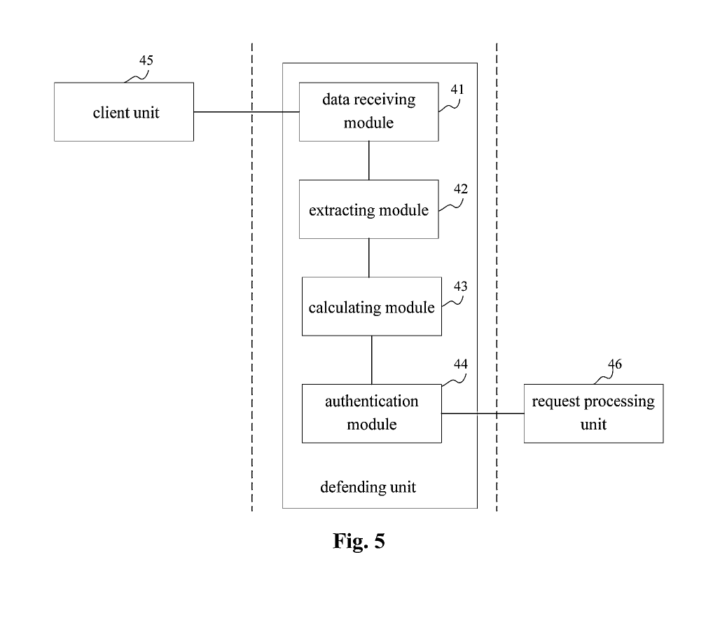

FIG. 5 is a block diagram of a structure of an apparatus for defending against a network attack according to a fourth embodiment. As shown in FIG. 5, the apparatus includes a defending unit, the defending unit includes a data receiving module 41, an extracting module 42, a calculating module 43 and an authentication module 44.

The data receiving module 41 is configured to receive data submitted by a client module.

The extracting module 42 is configured to extract a first authentication value from the data. The extracting module 42 may analyze the data based on a predetermined protocol, and extract the first authentication value from the received data.

The calculating module 43 is configured to calculate a second authentication value based on a predetermined algorithm. The calculating module 43 acquires a second specified factor, and calculates the second authentication value based on the second specified factor by applying the same algorithm as that applied by the client. The second specified factor may be stored in a server. For example, a hash value is calculated based on the second specified factor stored in the server and the MD5 algorithm, the hash value is the second authentication value.

The authentication module 44 is configured to compare whether the first authentication value matches with the second authentication value, and forward the data to a corresponding network server in a case that the first authentication value matches with the second authentication value, or discard the data in a case that the first authentication value does not match with the second authentication value.

Further, the apparatus for defending against a network attack in the embodiment may also include a client unit 45, which is configured to prepare the data to be sent; optionally, an application generates data to be sent to a network server in a running process, for example, recorded voice/audio data or operation data of a user in a game client program. Then, the client unit 45 may acquire the first authentication value. The first authentication value, e.g., a hash value, is calculated based on a first specified factor according to the Hash algorithm. The first specified factor is, for example, built in an application, and published along with the application. The second specified factor is the same as the first specified factor. The client unit 45 may add the first authentication value into the data to be sent after the first authentication value is acquired. Further, the client unit 45 sends the data to the data receiving module 41.

Further, the apparatus for defending against a network attack in the embodiment may also include a request processing unit 46, which is configured to perform corresponding data processing based on the data and return a processing result to the client unit 45 after receiving the data. In an example that the data is audio/voice data, the request processing unit 46 forwards the audio/voice data to other client, and returns a processing result to the client unit 45. In another example that the data is operation data of the user, the request processing unit 46 completes a corresponding operation, and returns a result after the operation is completed to the client unit 45.

Referring to FIG. 2, in one embodiment of the invention, the defending unit may be arranged in the defending server 20, the client unit 45 may be arranged in the client 10 and the request processing unit 46 may be arranged in the network server 30. In the embodiment, the client unit 45 adds the first authentication value into the data to be sent after the first authentication value is acquired and sends the data with the first authentication value to the defending server 20. The defending unit receives data submitted by the client 10, analyzes the data based on a predetermined protocol, extracts the first authentication value from the received data, acquires a second specified factor, and calculates the second authentication value based on the second specified factor by applying the same algorithm as that applied by the client, compares whether the first authentication value matches with the second authentication value, and forwards the data to the network server 30 in a case that the first authentication value matches with the second authentication value, or discard the data in a case that the first authentication value does not match with the second authentication value. The request processing unit 46 performs corresponding data processing based on the data and returns a processing result to the client unit 45 after the data from the defending server 20 is received.

In the apparatus for defending against a network attack in the embodiment, the first authentication value may be calculated by implanting the first specified factor into the client module, and the client adds the first authentication value into the data to be sent when performing data interaction with the network server. In other hand, the defending server may calculate the second authentication value by itself based on the factor stored in the server. It is easy to recognize whether the client is a possible attack source by comparing the first authentication value with the second authentication value, therefore, abnormal data may be discarded, and network attack for the network server 30 is decreased. In addition, the apparatus in the embodiment may run well on the basis of a proprietary network protocol, which overcomes a defect that an existing “challenge/response” way is unable to run on the basis of the proprietary network protocol. However, it may be understood that the apparatus of the embodiment is not limited to run on the basis of the proprietary network protocol.

It may be understood that each of the units or modules in the apparatus for defending against a network attack may be a software functional module constituted by a program instruction stored in a memory, a hardware functional module constituted as logic gates microcodes within a ROM, a processor or a controller, or a functional module constituted by both software/hardware together. The software functional module may be stored in a memory in client 10, a defending server 20 and network server 30 described above, or stored in a cloud memory, and the client 10, the defending server 20 and the network server 30 described above may access the software functional module via an internet.

The embodiments of the invention further provide a computer-readable storage medium, such as a hard disk, an optical disk, a solid sate memory such as a flash memory. The computer-readable storage medium stores a computer-executable instruction, and the computer-executable instruction is executed by one ore more processors, so that the computer or other similar arithmetic apparatus can realize the method and apparatus in various embodiment described above.

It is needed to illustrate that, in the disclosure, terms “include”, “comprise” or any other variations are intended to cover non-exclusive “include”, so that a process, a method, an object or an apparatus including a series of factors not only include the series of factors, but also include other factors not explicitly listed, or also include inherent factors of the process, the method, the object or the apparatus. Without more limitation, a factor defined in a sentence “include one . . . ” does not exclude a case that there is also another same factor in the process, the method, the object or the apparatus including the factor.

The foregoing are only preferred embodiments of the invention and therefore are not intended to limit the invention. Any changes, equivalent alternates and modifications and so on made within the spirit and principle of the invention will be included in the scope of the protection of the invention.

1. A method for defending against a network attack, comprising:
receiving, by a defending server, data submitted by a client;
extracting, by the defending server, a first authentication value from the data;
calculating, by the defending server, a second authentication value based on a predetermined algorithm; and
forwarding, by the defending server, the data to a corresponding network server in case that the first authentication value matches with the second authentication value.

2. The method according to claim 1, wherein before the step of receiving, by the defending server, data submitted by the client, the method further comprises the following steps:
preparing, by the client, the data to be sent;
calculating, by the client, a first hash value based on a first specified factor, wherein the first hash value is the first authentication value;
adding, by the client, the first hash value into the data to be sent; and
sending the data by the client, to the defending server.

3. The method according to claim 2, wherein the step of calculating, by the defending server, the second authentication value based on the predetermined algorithm, comprises:
calculating, by the defending server, a second hash value based on a second specified factor which is the same as the first specified factor, the second hash value is the second authentication value.

4. The method according to claim 1, further comprising: discarding the data by the defending server, in case that the first authentication value does not match with the second authentication value.

5. The method according to claim 1, further comprising: performing, by the corresponding network server, corresponding data processing based on the data after the data is received by the defending server, and returning a processing result to the client.

6. An apparatus for defending against a network attack applied in a defending server, comprising a processor and a memory which stores instruction codes operable as plurality of units or modules, wherein the plurality of units or modules include:
a defending unit, wherein the defending unit comprises:
a data receiving module configured to receive data submitted by a client;
an extracting module configured to extract a first authentication value from the data;
a calculating module configured to calculate a second authentication value based on a predetermined algorithm; and
an authentication module configured to forward the data to a corresponding network server in a case that the first authentication value matches with the second authentication value.

7. The apparatus according to claim 6, further comprising a client unit configured to:
prepare the data to be sent;
calculate a first hash value based on a first specified factor, wherein the first hash value is the first authentication value;
add the first hash value into the data to be sent; and
send the data to be sent with the first hash value to the data receiving module.

8. The apparatus according to claim 7, wherein the calculating module is configured to calculate a second hash value based on a second specified factor which is the same as the first specified factor, the second hash value is the second authentication value.

9. The apparatus according to claim 6, wherein the authentication module is further configured to discard the data in case that the first authentication value does not match with the second authentication value.

10. The apparatus according to claim 6, further comprising a request processing unit configured to, after the data is received by the corresponding network server, perform corresponding data processing based on the data, and return a processing result to the client.

11. A method for defending against a network attack, comprising:
adding, by a client, a first authentication value into data to be sent, and sending the data to a defending server;
receiving the data by the defending server, and extracting the first authentication value from the data;
calculating, by the defending server, a second authentication value based on a predetermined algorithm; and
forwarding, by the defending server, the data to a corresponding network server in case that the first authentication value matches with the second authentication value.

12. The method according to claim 11, wherein before adding, by the client, the first authentication value into the data to be sent, the method further comprises:
calculating, by the client, a first hash value based on a first specified factor, wherein the first hash value is the first authentication value.

13. The method according to claim 12, wherein the step of calculating, by the defending server, the second authentication value based on the predetermined algorithm, comprises:
calculating a second hash value based on a second specified factor which is the same as the first specified factor, the second hash value is the second authentication value.

14. The method according to claim 11, further comprising:
discarding, by the defending server, the data in case that the first authentication value does not match with the second authentication value.

15. The method according to claim 11, further comprising:
performing, by the defending server, data processing based on the data, and returning a processing result to the client after receiving the data.

16. A system for defending against a network attack, comprising a client, a defending server and a network server,
wherein the client is configured to add a first authentication value into data to be sent, and send the data to the defending server;
the defending server is configured to: receive the data and extract the first authentication value from the data; calculate a second authentication value based on a predetermined algorithm; and forward the data to the network server in case that the first authentication value matches with the second authentication value.

17. The system according to claim 16, wherein,
the client is further configured to calculate a first hash value based on a first specified factor, wherein the first hash value is the first authentication value.

18. The system according to claim 17, wherein the defending server is further configured to calculate a second hash value based on a second specified factor which is the same as the first specified factor, the second hash value is the second authentication value.

19. The system according to claim 16, wherein the defending server is further configured to discard the data in case that the first authentication value does not match with the second authentication value.

20. The system according to claim 16, wherein the network server is configured to perform corresponding data processing based on the data, and return a processing result to the client after receiving the data forwarded by the defending server.
